(19) United States
(12) Patent Application Publication
(10) Pub. No.: US 2016/0078066 A1
(43) Pub. Date: Mar. 17, 2016

(54) METHOD AND APPARATUS FOR PROCESSING CLINICAL DATA

(71) Applicant: FIGMD, Inc., Hanover Part, IL (US)

(72) Inventor: Sanket BARALAY, Hanover Part, IL (US)

(21) Appl. No.: 14/848,797

(22) Filed: Sep. 9, 2015

Related U.S. Application Data
(60) Provisional application No. 62/049,012, filed on Sep. 11, 2014.

(51) Int. Cl. G06F 17/30

(52) U.S. Cl. CPC G06F 17/30294; G06F 17/30377; G06F 17/30368

(57) ABSTRACT

Embodiments are concerned with a method, apparatus and computer software for performing a database structure comparison process. The database structure comparison process comprises the steps of:
receiving a first schema of a first database adapted to store first clinical data;
generating a first hash of the first schema;
receiving first clinical data from the first database;
storing the first data in a central database using a schema relationship, the schema relationship describing a relationship between the first schema and a schema of the central database;
receiving a second schema of the first database;
generating a second hash of the second schema;
comparing the first hash and the second hash, whereby to establish that there is a difference between the first schema and the second schema; and
responsive to a determination that there is a difference, selectively arranging for the schema relationship to be updated.

### CROSS REFERENCE TO RELATED APPLICATIONS

This application claims the benefit under 35 U.S.C. §119(e) of U.S. Provisional Patent Application No. 62/049,012, filed Sep. 11, 2014, the entire content of which is incorporated herein by reference.

### BACKGROUND OF THE INVENTION

1. Field of the Invention

Embodiments of the present disclosure relate to methods, apparatus and computer software for processing clinical data.

2. Description of the Related Technology

Clinical data registries collect clinical data from medical practices, for the purpose of monitoring and improving quality of care. Typically a practice stores such clinical data in a clinical database stored on a practice EMR (Electronic Medical Records) server, also known as a practice EHR (Electronic Health Records) server. The software for an EMR is typically provided to a practice from a third-party EMR vendor, of which a large number exist.

In order to develop a full picture of patient care, it is desirable to collect data from a variety of practices. For example, a patient may visit multiple practices in different clinical areas such as a cardiology practice and an ophthalmology practice, and treatments or diagnoses at one practice may affect the best course of action at another practice. It is also desirable to collect data from many practices in the same clinical area as, for example, a manager may wish to monitor performance of all cardiology practices under their management.

The structure of a database may be described by a database schema. By way of example, a relational database includes a set of tables containing related data. A schema describes the configuration of these tables and the relationships between them. Clinical database structure is not standardized and thus varies between practices, depending on the EMR vendor from which the software is provided.

Clinical databases vary further in the format used to store a given chunk of data. For example, gender may be stored in various formats including a string such as “male” or “female”, a character such as “M” or “F”, or a binary value (0 or 1). The schema or data formats used by a given practice may vary over time, for example due to changes in practice IT systems.

Due to the differences in schema and data format between different practices, as well as the possibility of changes in schema and format, known clinical data registries typically do not collect data directly from practice EMR servers. Instead, known registries typically require the data to be provided in a specified form, with no accommodation provided for changes in this form. This limits the range of practices from which data may be collected. There is thus a need for a more flexible clinical data registry system.

### SUMMARY

Embodiments are concerned with a method, apparatus, and computer software for performing a database structure comparison process according to the appended claims. According to a first aspect of the present disclosure, there is presented a method, comprising performing a database structure comparison process, the database structure comparison process may comprise the steps of:

receiving a first schema of a first database adapted to store first clinical data;
generating a first hash of the first schema;
receiving first clinical data from the first database;
storing the first data in a central database using a schema relationship, the schema relationship describing a relationship between the first schema and a schema of the central database;
receiving a second schema of the first database;
generating a second hash of the second schema;
comparing the first hash and the second hash, whereby to establish that there is a difference between the first schema and the second schema; and
responsive to a determination that there is a difference, selectively arranging for the schema relationship to be updated.

As a result, a change in the schema of the first database can be immediately detected. This enables the schema relationship to be updated, which in turn enables further data from the first database to be correctly stored in the central database. The method thus enables adaptation to a change in schema of the first database, which allows data to be received directly from an EMR without being converted to a different structure in the local practice from which the first clinical data originates. As a consequence, data may more efficiently be received from a range of practice, or Electronic Medical Records (EMR) servers. In the present disclosure, the first database is alternatively referred to as a practice database and/or a source database, while the central database is alternatively referred to as a clinical data repository. In one arrangement a new schema relationship may be defined, and in another the existing schema relationship—namely the first schema—may be maintained.

The method may further comprise:

receiving second clinical data from the first base, the second clinical data being structured according to the second schema; and
after performing the step of arranging for the schema relationship to be updated, storing the second clinical data in the central database using the schema relationship. In this manner, the updated schema relationship may be applied to store further data from the first database after a change in structure of the first database.

In an embodiment, the method may further comprise outputting an alert indicating that there is a said difference, while the step of arranging for the schema relationship to be updated may comprise:

receiving data indicative of the difference; and
updating the schema relationship in accordance with the received data so as to incorporate the difference between the first and second schemas.

In this way an administrator may be promptly alerted of the difference, which may for example comprise changes in column structure such as the addition, renaming, or deletion of columns, changes in data type, changes of table structure such as the addition, renaming or deletion of tables, changes in relationships between tables or changes in database objects such as stored queries, procedures and views. The skilled person will appreciate that this list is exemplary and that other aspects of a database schema fall within the scope of the present disclosure. In response, the administrator can perform an offline process, for example involving inputting data to update the schema relationship. This allows efficient updates to the schema relationship.

The schema relationship may be described via a mapping function between at least one set of tables of the first database and a set of tables of the central database. This provides an efficient way to transform data organized according to the schema of the first database into data organized according to the schema of the central database, which allows the clinical data from the first database to be stored in the central database in a timely manner.

Typically, the first clinical data comprises a plurality of fields, each of which has a data format; the step of storing the first clinical data in the central database may include converting the data format of at least some of said fields into a format compatible with a data format of corresponding fields of the central database on the basis of a format relationship, the format relationship describing a relationship between the data format of at least some of said fields of the first clinical data and the data format of corresponding fields of the central database. This has the consequence that the central database may receive data from clinical databases which do not use the same data format. This increases the number of source databases from which data may be received.

In a further embodiment, the method further may comprise:

responsive to a request from a user, operating a user device remote from said central database, retrieving clinical data from the central database; and
transmitting the retrieved clinical data to the remote user device, which may be a wearable computing device,
wherein said retrieval of clinical data is dependent on the identity of the user. This enables the clinical data stored in the central database to be presented differently to different users depending on their role in the clinical ecosystem. For example, a patient could be presented with their own medical records, a doctor could be presented with data for all their patients, and a manager could see data for all practices under their management. Data may also be delivered in an appropriate form directly to a user's wearable device. This enables immediate use of that data. For example, where the user is a doctor, data could be delivered detailing a patient's medical history, or recommended interventions, while the patient is present in the surgery. The doctor may then use this information to improve diagnosis or treatment of the patient

In one arrangement, the method further may comprise performing a data format comparison process, the data format comparison process may comprise the steps of:

receiving first format data indicative of a said data format of at least one said field of the first clinical data;
generating a third hash of the first format data;
receiving second format data indicative of a said data format of the at least one said field of the first clinical data;
generating a fourth hash of the second format data;
comparing the third hash and the fourth hash, whereby to establish that there is a change between the first format data and the second format data; and
responsive to a determination that there is a change, arranging for the format relationship to be updated. This has the effect that a change in format of the received data may be promptly detected and accommodated. In consequence, a practice from which data is received need not indicate a change in a data format of its clinical database.

In some embodiments, the method may further comprise performing the data format comparison process for a second and other said fields of the first clinical data. Further, the method may comprise selectively performing the data format comparison process for a second field of the first clinical data based on historical data indicative of how frequently it has been established that there is a change between the first format data and the second format data for a given second field. As such, the efficiency of the process may be increased by not performing the process on fields for which the formats are unlikely to change.

According to some arrangements, the method may further comprise outputting an alert indicating that there is a change, and preferably the step of arranging for the format relationship to be updated comprises receiving data indicative of the change; and updating the format relationship in accordance with the received data so as to incorporate the change between the first and second format data. As noted above, in one arrangement an administrator may be promptly alerted of the said difference, which for example may comprise differences in date formats, name formats, or formats of medical diagnoses between different versions of a given database. In response, the administrator can perform an offline process, which may include inputting data to update the format relationship to reflect the change. This allows the format relationship between the first format—typically, but not always, earlier version of the database—and the second format to be efficiently updated.

Preferably, the format relationship is a mapping function between at least one set of formats of fields of the first database and a set of formats of fields of the central database. This provides an efficient way to transform data from a data format used by the first database into a data format used by the central database, which allows the clinical data from the first database to be stored in the central database in a timely manner.

In a preferred embodiment, the method further may comprise performing the database structure comparison process on a second database adapted to store clinical data. This allows data to be received from multiple clinical databases, which allows data for a given patient to be collected from multiple practices, providing a wide overview of the patient's medical records. This improves patient care by allowing more data to be considered when making diagnoses and prescribing treatments. Further, this enables data relating to a given medical condition as it applies to multiple patients to be collected and analyzed on a greater scale and more efficiently than is possible with conventional systems for processing clinical data. For example, data for multiple practices in the same practice area, for example cardiology, may be automatically collected into a central database and analyzed centrally with the corresponding performance benefits. This improves quality control by, for example, allowing analysis of the comparative performance of different practices and improves patient care by analyzing a significant range of data sources that have been normalized in terms of disparate database schemas and data formats.

According to some aspects of the disclosure, the first clinical data and second clinical data comprise clinical trial data. A consequence of using the method with clinical trial data is that data can be efficiently aggregated from various sources as the trial progresses, instead of collecting data in a defined format, for example at the end of the trial. This allows closer monitoring of the clinical trial and the progress of participating patients.

In a further embodiment, at least some of the first clinical data and at least some of the second clinical data may comprise performance monitoring data. This has the effect that data may be actively monitored across multiple practices. For example, data may be received frequently from practice servers without needing to be converted by the practice, and can thus be promptly analyzed. This allows rapid identification of changes in performance, which in turn allows prompt intervention.

Further features and advantages of the disclosure will become apparent from the following description of preferred embodiments of the disclosure, given by way of example only, which is made with reference to the accompanying drawings.

### BRIEF DESCRIPTION OF THE DRAWINGS

FIG. 1 shows a system architecture including a medical practice and a registry within which embodiments of the present disclosure may be practiced.

FIG. 2 shows a method for receiving data from a source database and storing it in a central database, and updating a relationship between the schema of the source database and the schema of the central database according to an exemplary embodiment.

FIG. 3 shows a method for receiving data from a source database and storing it in a central database, updating a relationship between the schema of the source database and the schema of the central database, and receiving further data from the source database and storing it in the central database according to an exemplary embodiment.

FIGS. 4a-4f show exemplary output from the registry of FIG. 1 in the form of views of medical data which may be presented to different users.

FIG. 5 shows a system comprising multiple source databases and a single processor and central database according to an exemplary embodiment.

FIG. 6 shows a method for configuring a relationship between the schema of a source database and the schema of a central database according to an exemplary embodiment.

### DETAILED DESCRIPTION OF CERTAIN INVENTIVE EMBODIMENTS

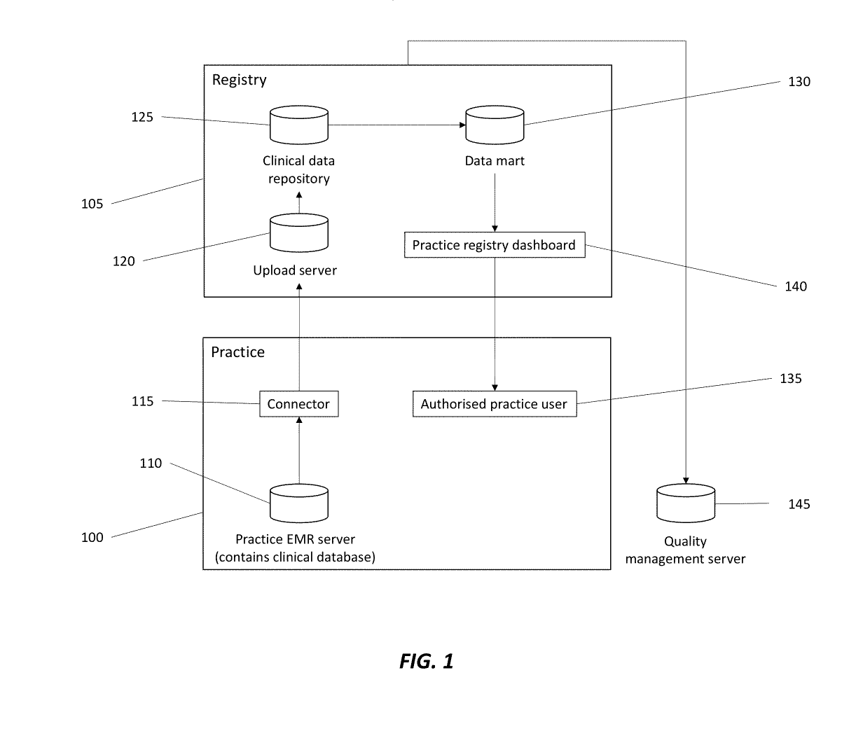

A system architecture according to some embodiments of the present disclosure is shown in FIG. 1, which depicts a medical practice 100 and a clinical data registry 105. The medical practice includes a practice EMR server 110 which contains a clinical database, and a connector 115. The connector may comprise a software client configured to enable the registry to interface with the practice. The connector retrieves structured clinical data from the practice EMR server and provides it to an upload server 120 in the registry, which may occur at specified regular intervals for example nightly, or in response to a specific request.

The upload server 120 stores the clinical data in a clinical data repository 125. The clinical data may be stored as raw clinical in its original form, with relationship information such as a map indicating the schema and/or data formats used by the practice EMR server. Alternatively, the relationship information may be used to transform the clinical data into a common format for storage in the clinical data repository.

The data in the clinical data repository is transformed into one or more marts 130. A data mart may comprise a mission-specific grouping of clinical data. For example, a data mart may include data required for calculating the quality indicators required by the Physician Quality Reporting System (PQRS), a standard set by Centers for Medicare and Medicaid Services (CMS).

An authorized practice user 135 may access the clinical data in a given data mart via a connection to a practice registry dashboard 140. The user may be presented with different information depending on their needs. For example, the information requested by a doctor may be limited to information corresponding to their own patients, or their own performance data. As another example, the information requested by a practice manager may be limited to information regarding the performance of their practice.

Information from the registry 105 may also be provided to a quality management server 145, which may not be located within a specific practice. This allows a healthcare organization to review the performance of a number of practices, for example within a given practice area. This also allows analysis of quality control procedures that are in place across the whole system including the registry and practice.

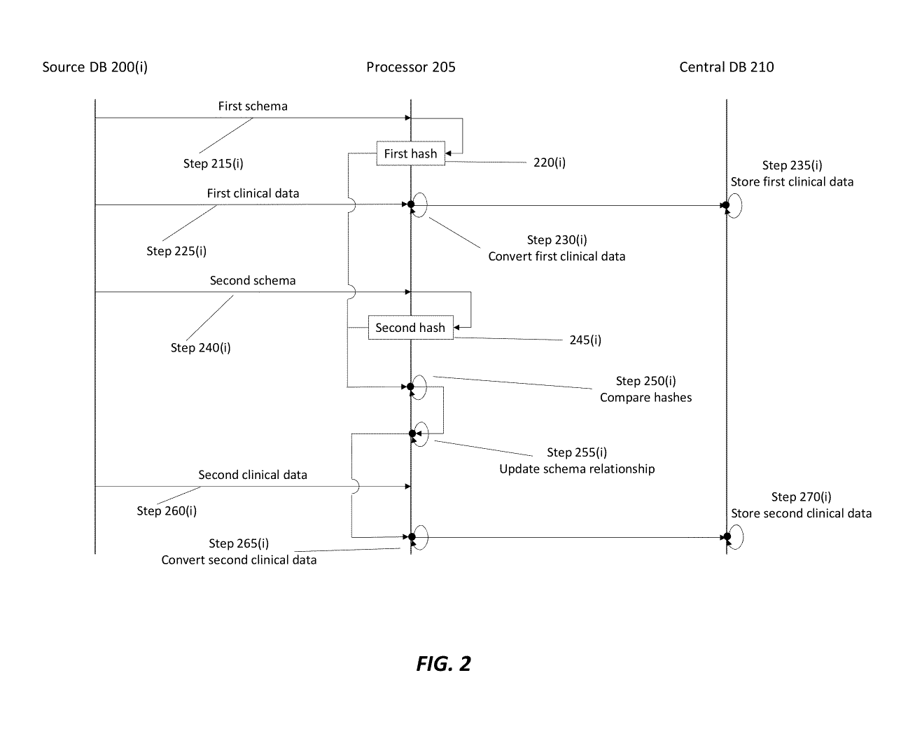

A method including a database structure comparison process according to some embodiments will now be described with reference to FIG. 2. A source database 200(i) is connected to a processor 205. The index “i” refers to a first source database 200(i), and steps and data referred to with this index refer to operations and data relating to data originating in said first source database 200(i). Additional source databases are referred to by indices “i+1”, “i+2”, etc. The source database 200(i) is adapted to store clinical data and may be stored on a practice EMR server 110. The processor 205 may preferably be located at a registry 105 within the same computer system as an upload server 120, clinical data repository 125, or data mart 130. A central database 210 is stored in a location accessible to the processor which may for example be in a clinical data repository 125 or a data mart 130. The structure of the source database 200(i) and the central database 210 are described by database schemas, and a schema relationship is stored which describes a relationship between the schema of the source database and the schema of the central database. The schema relationship may, for example, be a mapping function describing a mapping between tables of the source database and corresponding tables of the central database.

A first schema describes the structure of the source database 200(i). The first schema is received (step 215(i)) at the processor 205 at time t0 and is hashed, generating a first schema hash 220(i). The hashing may involve a known hashing algorithm such as MD5 or a digest function. The hashing step may also involve use of a general function to map received data onto different output data.

First clinical data, structured as described by the first schema, are transmitted (step 225(i)) from the source database 200(i) to the processor 205. The schema relationship is used to convert (step 230(i)) the first clinical data to a form suitable for storing in the central database 210, following which the first clinical data is stored (step 235(i)) in the central database 210.

At a time t1 after the time of transmission (step 215(i)) of the first schema, a second schema describing the structure of the source database 200(i) at time t1 is received (step 240(i)) at the processor 205. The second schema is hashed, producing a second schema hash 245(i).

The first and second schema hashes 220(i), 245(i) are compared (step 250(i)). If a change in the structure of the source database 200(i) occurs between the transmission (step 215(i)) of the first schema at time t0 and the transmission (step 240(i)) of the second schema at time t1, the first and second schemas will be different and thus the first and second hashes 220(i), 245(i) will also be different. If a difference between the schemas is detected, the schema relationship may be updated (step 255(i)) such that the updated schema relationship incorporates the difference between the first and second schemas.

In response to identifying a difference between the first and second schema hashes 220(i), 245(i), according to some embodiments an alert may be output. This may, for example, alert an administrator to update the schema relationship.

In an exemplary aspect of the present disclosure, the schema relationship may be updated by the processor 205 receiving data indicative of the difference between the first schema and the second schema, following which the processor 205 may update the schema relationship to incorporate the difference. The input data may, for example, be provided by an administrator or may be at least partially algorithmically generated by analysis of the first and second schemas. As an illustrative example, the administrator may be presented with a textual or visual representation of the first and second schemas, along with the schema of the central database 201. The administrator may then produce a file indicating the differences, for example a change in name of a field, an addition of a new field, or the deletion of an existing field. On receiving this file, the processor may update (step 255(i)) the schema relationship by, for example, changing the name of a given field of the source database 200(i) in a mapping from the source database 200(i) to the central database 210.

Optionally, second clinical data may be received (step 260(i)) at the processor 205, at a time t2 after the transmission of the second schema. As such, the second clinical data is typically structured according to the second schema. The updated schema relationship is used to convert (step 265(i)) the second clinical data to a form suitable for storing in the central database 210, following which the second clinical data is stored (step 270(i)) in the central database 210.

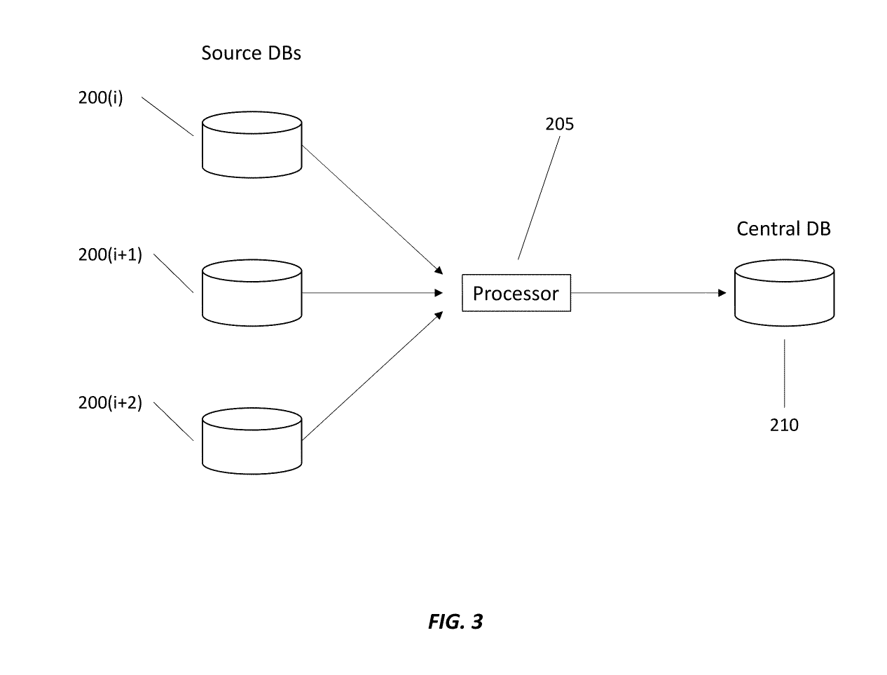

FIG. 3 illustrates a further embodiment, which involves receiving data from a second clinical database 200(i+1), e.g. hosted at a second practice. The database 200(i+1) of this practice has its own schema, and, as for the first clinical database 200(i) described with reference to FIG. 2, data may be received from this second practice 200(i+1) and consolidated efficiently into the central database 210 of the registry 105 according to the process described with reference to FIG. 2. As such, the steps and data 215(i)-270(i) described in the context of the first clinical database 200(i) are repeated for the second clinical database 200(i+1) as 215(i+1)-270(i+1).

The skilled person will appreciate that any number of second clinical databases, for example 200(i+2) as indicated in FIG. 3, can be processed according to the presently described embodiments, with corresponding benefits in terms of scalability and homogenization of data from disparate practices. As such, data from multiple sources, which may be structured according to different schemas, may be incorporated in the central database 210.

Data stored in the central database 210 may be accessed by a user operating a user device remote from the first source database 200(i), for example in a medical practice 100. The data may be retrieved from the central database 210 and presented to the user differently depending on the identity of the user. For example, as stated above a doctor may be presented with data regarding their patients, and a practice administrator may be presented with data regarding the doctors in their practice. In some embodiments, the user device may be a wearable device, such as a smart watch or an optical head-mounted display, for example Google Glass®. As such, the data stored in the central database 210 may be filtered based on the role of the user, where the role may be, for example, “doctor” or “practice manager”. This may be implemented by selecting relevant fields in the central database 210 in response to a query, the query including the role of the user. This may be verified by, for example, requiring the user to enter authentication information such as a password.

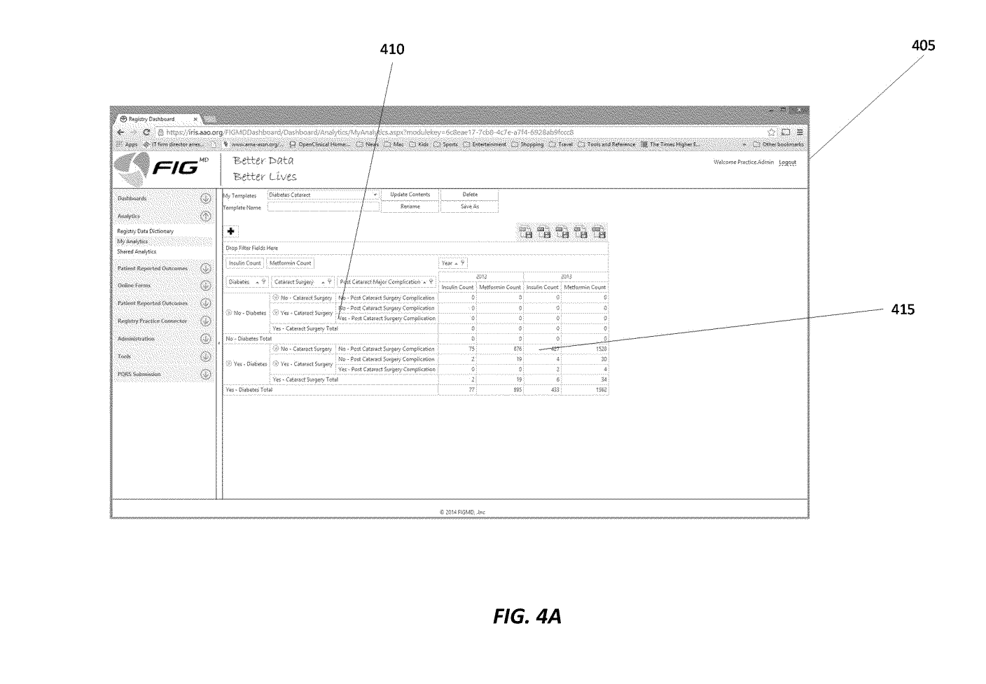

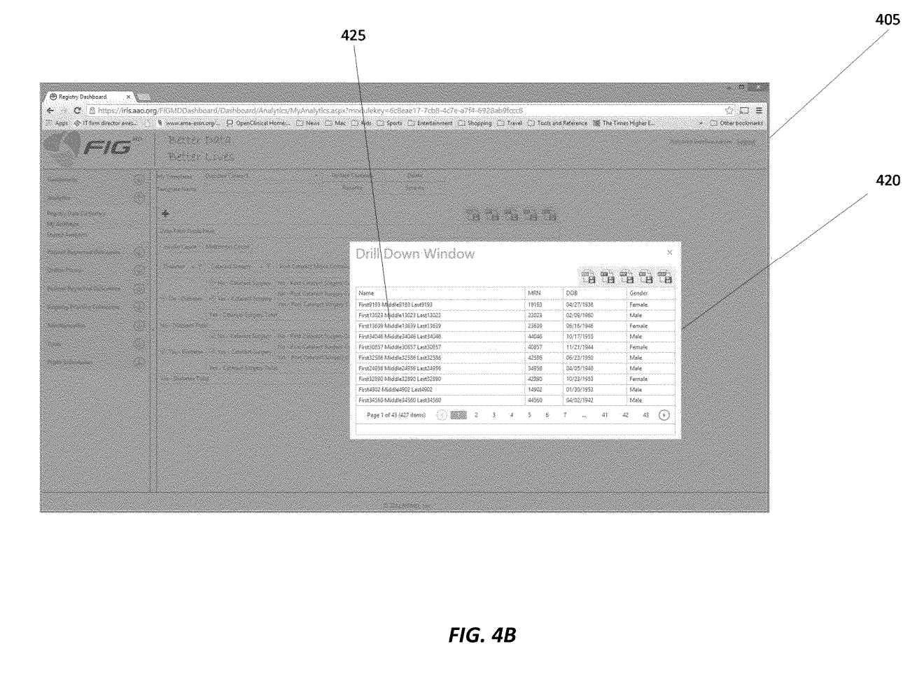

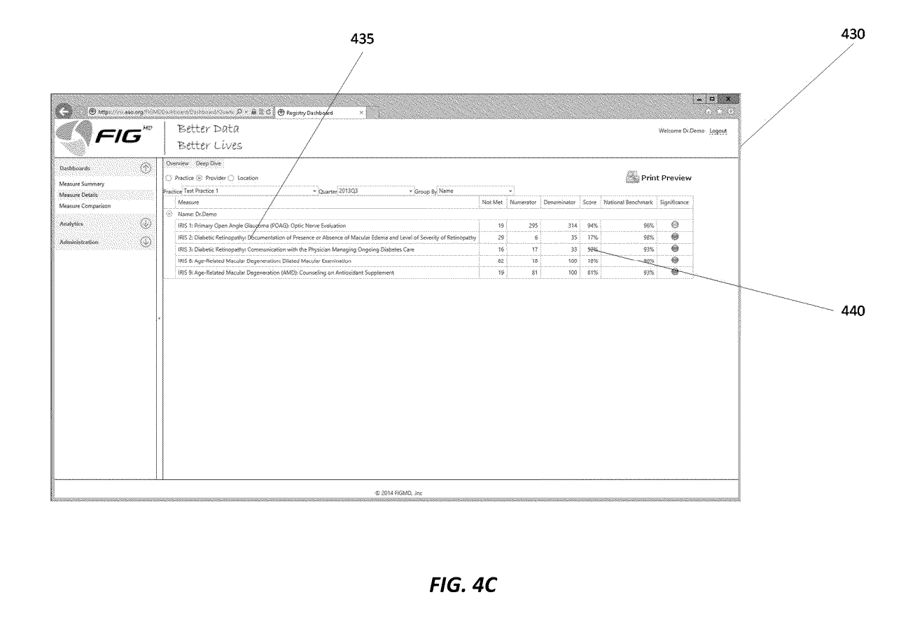

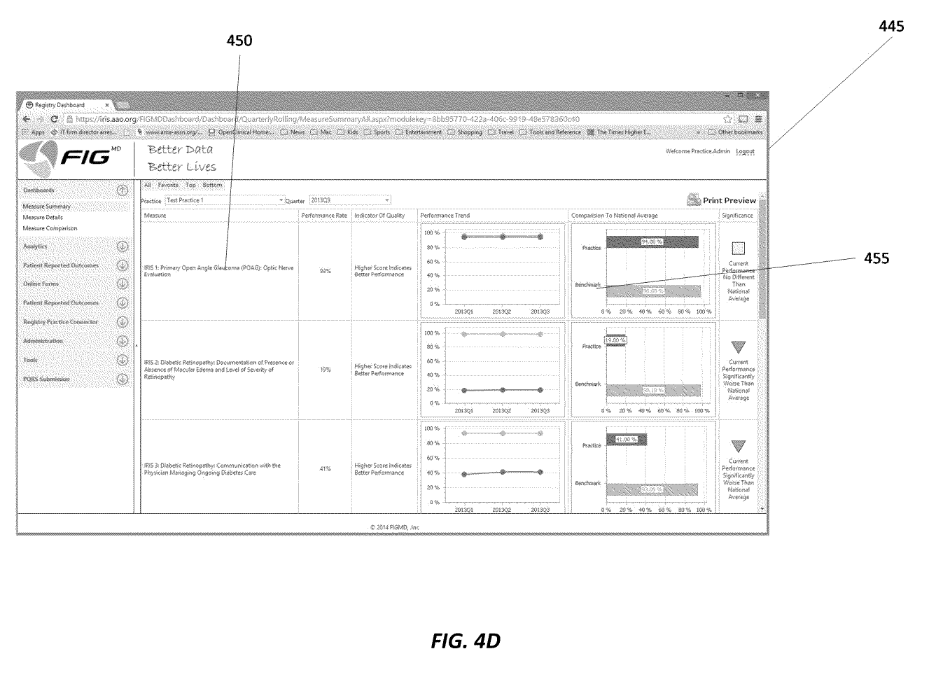

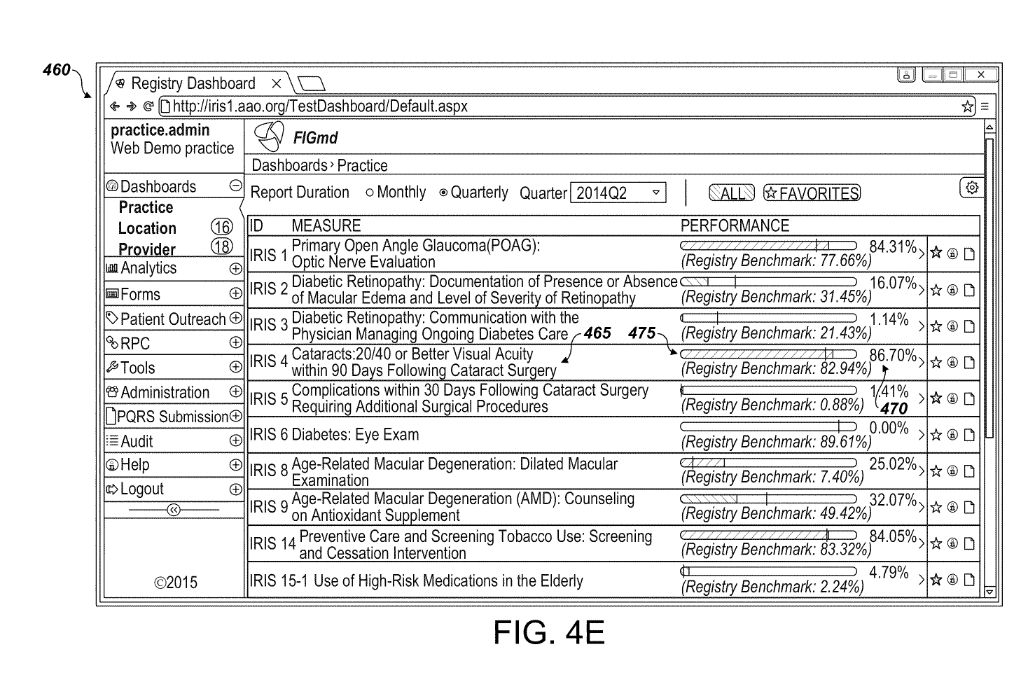

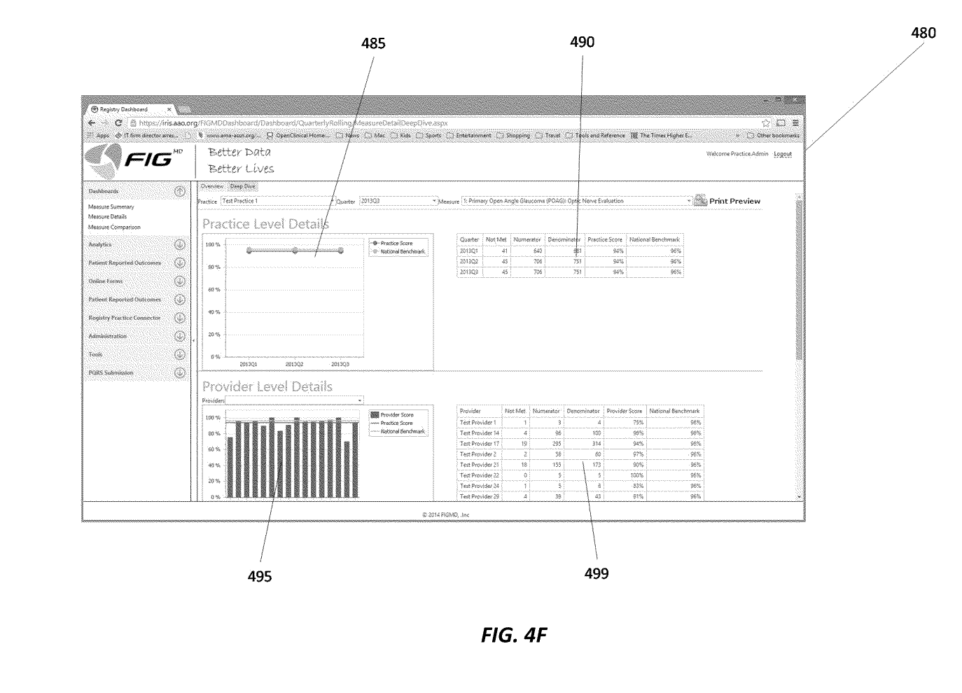

Examples of the manner in which data may be presented to different users are presented in FIGS. 4a-4f. FIGS. 4a-4c show examples according to some embodiments, in which the user is a doctor. FIG. 4a shows a window 405 in which a doctor may view possible interventions 410 for a given ailment, in this case diabetes. The doctor may view statistics 415 regarding the interventions prescribed for their patients. Interventions may be, for example, prescriptions of medication or courses of treatment.

The doctor may further view data corresponding to their individual patients, as shown in FIG. 4b. FIG. 4b shows a window 420 which may be overlaid on the window 405. The window 420 contains a list 425 of the doctor's patients. In this example the list 425 is anonymized, with patients being identified by ID numbers, but the patients may alternatively be identified by their names. The doctor may select individual patients from the list 425, following which the doctor may be presented with more detailed information regarding the medical records of that patient.

FIG. 4c shows a third example of a manner in which data may be presented to a doctor. A window 430 contains a list 435 of potential medical interventions. For each potential intervention, statistics may be presented as a score 440 representing, for example, the proportion of times the doctor prescribed each intervention to a patient for whom that intervention was recommended. The statistics may also include a comparison with a benchmark or an average for the doctor's practice or region.

FIGS. 4d-4f show examples of presentation of data according to some further embodiments, in which the user is a manager of a medical practice. FIG. 4d shows a window 445 containing a list 450 of medical interventions. For each intervention, statistics are presented in graphs 455 regarding the performance of the practice, for example expressed as the percentage of patients, for whom each intervention was recommended, who were prescribed that intervention. The statistics may include a comparison of practice performance with a benchmark or a national average.

FIG. 4e shows an alternative set of statistics. A window 460 contains a list 465 of potential medical interventions which may be recommended for a patient with a given medical condition. For each intervention 470, figures are presented describing the performance of the practice. An indicator of practice performance 475 may be included, for example indicating areas in which the practice is under-performing with regard to benchmarks. These areas may then be further investigated.

FIG. 4f shows a further presentation of data which may be available to a manager of a practice. A window 480 presents a graph 485 and FIGS. 490 indicating the performance of the practice as a whole, compared with a national benchmark. Also shown are statistics for each doctor at the practice, which may be presented as a graph 495 or as FIGS. 499. Each doctor may thus be individually compared with national benchmarks, and underperforming doctors may be identified for further investigation.

As will be appreciated by the skilled person, databases generally comprise a plurality of fields, with the data entry in each field being stored in a given data format. For example, as described above, an entry for gender may be stored in various data formats including a character such as “M” or “F”, a string such as “male” or female”, or a binary value (0 or 1). Analogously to the schema relationship, a format relationship may be stored which describes a relationship between the data format of at least one of the fields of the source database 200(i) and the data format of the corresponding fields of the central database 210. The format relationship may, for example, be a mapping function between formats of fields of the source database 200(i) and formats of corresponding fields of the central database 210.

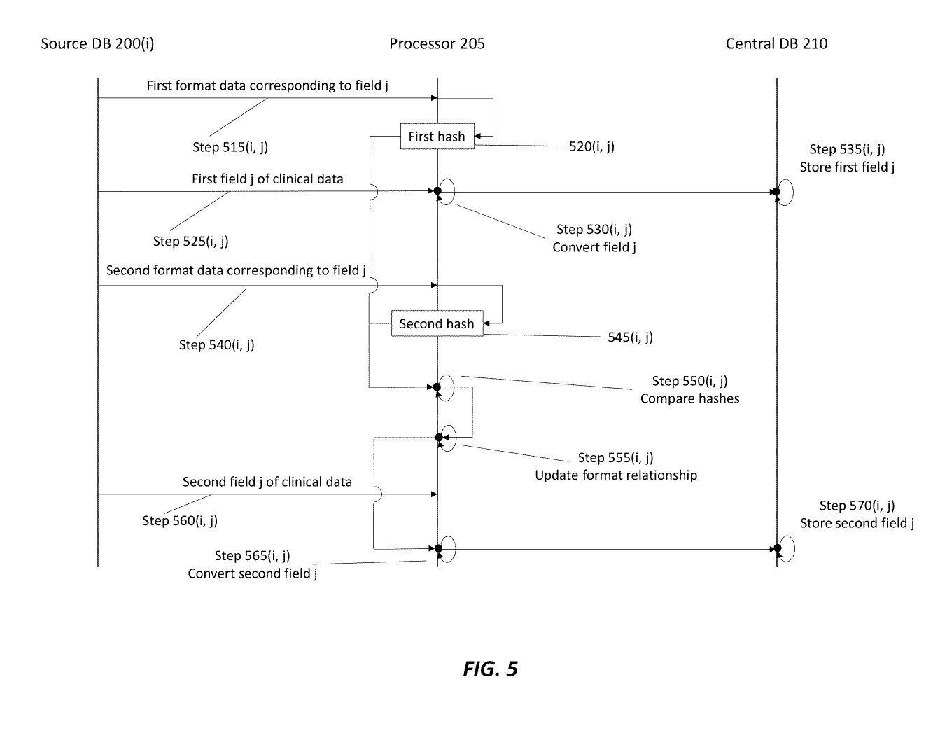

A method of performing a data format comparison process which may, according to some embodiments, be performed additionally to the schema comparison process shown in FIG. 2, will now be described with reference to FIG. 5. The method may be performed on fields of the same clinical data as that of FIG. 2, and may be performed in parallel with the process described with reference to FIG. 2. Analogously to the description above, the first source database 200(i) is identified by the index “i”. First format data indicative of the data format of at least one of the fields, j, of the first source database 200(i) is received at the processor 205 (step 515(i, j) at time t3, which may be contemporaneous with time t0. The index “j” indicates a specific field of the source database 200(i), for example “gender”, “name”, “diagnosis”, “treatment” or “date of birth”. The format data may, for example, comprise the content of entries in field j of the source database 200(i), or it may comprise a separate indication of the format such as an identification code. The format data is hashed, producing a first hash 520(i, j).

A first field j of the clinical data is transmitted (step 525(i, j) from the source database 200(i) to the processor 205. The skilled person will appreciate that when the first format data transmitted at step 515(i, j) comprises the content of field j, step 525(i, j) may be redundant, as the format may be derived from the content of field j that has already been received. The format relationship is used to convert (step 530(i, j)) the format of first field j to a format suitable for storing in the central database 210, following which the content of the first field j is stored in the central database 210 (step 535(i, j).

At time t4, where time t is after time t3 and may be contemporaneous with time t1, second format data describing a second instance of the format of field j is transmitted from the source database 200(i) to the processor 205. The second format data is hashed, producing a second hash 545(i, j).

The hashes 520(i, j) and 545(i, j) are compared (step 550(i, j)). If a change in data format for field j has occurred between time t3 and time t4, the first and second format data will be different and thus the hashes will be different. If such a difference is detected, the format relationship may be updated (step 555(i, j)) to reflect the change. The format relationship may be updated by the processor 205 receiving data indicative of the change of format, after which the processor 205 may update the format relationship to incorporate the change. Analogously to the above-described embodiment regarding the schema relationship, the data indicative of the change may be, for example, provided by an administrator or be at least partially algorithmically generated.

Optionally, a second instance of the content of field j of the source database 200(i) is transmitted from the source database 200(i) to the processor 205 at a time t5 after the transmission of the second format data corresponding to the second instance of field j, which may be contemporaneous with time t3 (step 560(i, j)). As such, the second instance of field j will typically be in the format indicated by the second format data. The format relationship updated at step 555(i, j) is used to convert the second instance of field j to a format suitable for storing in the central database 210 (step 565(i, j)), following which the second instance of field j is stored in the central database 210 (step 570(i, j)).

The above-described process may be iterated, in parallel or sequentially, for an additional field j+1, and further fields, j+n. The fields over which the process is iterated may comprise all fields of the source database 200(i). Alternatively, specific database fields may be selected for this format comparison process. Selection of the fields may be based on historical data indicative of how frequently the formats of given fields are observed to change, or may be based on information provided by an administrator. An administrator may select the fields to include in the format comparison process by, for example, identifying fields for which the format is considered likely to change, while an automated method may track changes to the data formats and trigger an automated check of only those fields with data formats that the processor 205 has identified to have changed more than a predetermined number of times during initial collection of data from the source, or practice, database 200(i).

As with the schema comparison process described above with reference to FIG. 2, the method described with reference to FIG. 5 may be extended to additional source databases. As such, the steps and data 515(i, j . . . j+n)-570(i, j . . . j+n) may be repeated for a second source database 200(i+1, j . . . j+n) as 515(i+1, j . . . j+n)-570(i+1, j . . . j+n). As described above, the skilled person will appreciate that this data format comparison process may be performed for any number of second clinical databases, as indicated in FIG. 3.

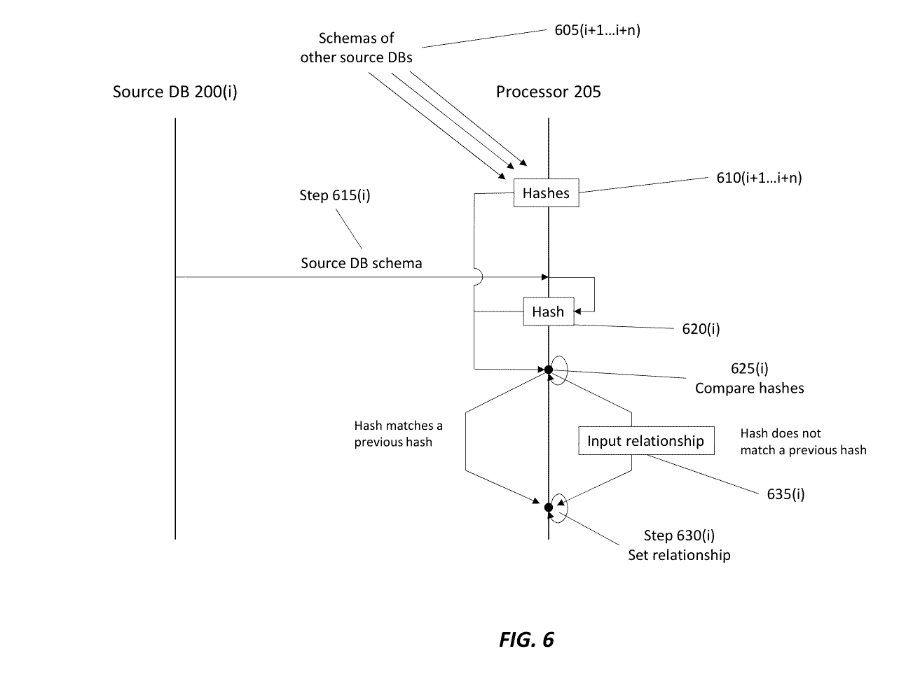

FIG. 6 depicts a method for generating a schema relationship, and optionally format relationship, for a new source database 200(i) for which no existing schema relationship is available, for example when first incorporating a new source database into the registry system. Schemas 601(i+1 . . . i+n) of other source databases i+1 . . . i+n for which schema relationships are known are received at the processor 205 and hashed, producing hashes 610(i+1 . . . i+n). Format data indicative of the data format of at least one field of the other source databases may also be received at the processor 205 and hashed.

The schema of the new source database 200(i) is received (step 615(i)) at the processor 205 and hashed, producing a hash 620(i). The hash 620(i) is compared to the hashes 610(i+1 . . . i+n) of schemas 605(i+1 . . . i+n) of the other source databases in a comparison step 625(i).

If the hash 620(i) matches one of the hashes 610(i+1 . . . i+n) of schemas 605(i+1 . . . i+n) of the other source databases, it may be inferred that the new source database 200(i) is structured according to the same schema as the matching one of the other source databases. The schema relationship is then set to be equal to the existing schema relationship of the matching one of the other source databases (step 630(i)).

If the hash 504 does not match one of the hashes 610(i+1 . . . i+n) of schemas 605(i+1 . . . i+n) of the other source databases, it may be inferred that the new source database 200(i) is not structured according to the same schema as any existing source database. In this case, a new schema relationship 635(i) is input, following which the schema relationship is set to be equal to the input schema relationship (step 630(i)). The new schema relationship may for example be input by an administrator or be generated algorithmically by comparison of elements of the schema of the new source database 200(i) with elements of the schemas 605(i+1 . . . i+n) of other source databases.

Analogously, format data indicative of the data format of at least one field of the new source database 200(i) may be received at the processor and hashed. This hash may be compared to the hashes of format data of a corresponding field of the other source databases. Accordingly, a process similar to the above described process may also be performed following comparison of hashes of format data for each field of the new source database 200(i). If the hash of the format data of a given field of the new source database 200(i) matches the hash of the format data of a corresponding field of one of the other source databases 605(i+1 . . . i+n), it may be inferred that the new source database 200(i) and the matching one of the other source databases utilize the same data format for the field or fields described by the format data. The format relationship for the said field or fields of the new source database 200(i) may then be set equal to the format relationship for the matching one of the other source databases. If the hashes do not match, it may be inferred that the new source database 200(i) does not use the same data format for the said field or fields as any of the other source databases. A new format relationship may then be input, for example by an administrator or by algorithmic generation by comparison of fields of the new source database 200(i) with fields of the other source databases 605(i+1 . . . i+n).

It should be noted that the use of the word “steps” in this disclosure does not imply that the steps are performed in any given order. As an illustrative example, with reference to FIG. 2, step 260(i) may be performed before or in parallel with step 240(i). As a further example, with reference to FIG. 3, step 301 may be performed before or in parallel with step 209.

The example embodiments described above can be implemented in many ways, such as program instructions for execution by a processor, as logic circuits, as an application specific integrated circuit, as firmware, etc. For example, the embodiments can be implemented as one or more software or firmware applications, computer-implemented methods, program products stored on a computer useable medium, for execution on one or more processors (e.g., CPU, microcontroller) or other computing devices in a wireless station.

The above embodiments are to be understood as illustrative examples. Further embodiments are envisaged. For example, the source database or databases may be known as EMRs, EHRs, Practice Management Systems, or health information systems. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, certain embodiments of which are defined in the accompanying claims.

What is claimed is:

1. A method of processing clinical data, the method comprising:
configuring at least one processor and at least one memory including computer program instructions to perform a database structure comparison process, the database structure comparison process comprising the steps of:
receiving a first schema of a first database adapted to store first clinical data;
generating a first hash of the first schema;
receiving first clinical data from the first database;
storing the first data in a central database using a schema relationship, the schema relationship describing a relationship between the first schema and a schema of the central database;
receiving a second schema of the first database;
generating a second hash of the second schema;
comparing the first hash and the second hash, whereby to establish that there is a difference between the first schema and the second schema; and
responsive to a determination that there is a difference, selectively arranging for the schema relationship to be updated.

2. The method of claim 1, further comprising configuring the at least one processor and the at least one memory including computer program instructions to perform the steps of:
receiving second clinical data from the first base, the second clinical data being structured according to the second schema; and
after performing the step of arranging for the schema relationship to be updated, storing the second clinical data in the central database using the schema relationship.

3. The method of claim 1, further comprising configuring the at least one processor and the at least one memory including computer program instructions to output an alert indicating that there is a difference.

4. The method of claim 1, wherein the step of arranging for the schema relationship to be updated comprises:
receiving data indicative of the difference; and
updating the schema relationship in accordance with the received data so as to incorporate the difference between the first and second schemas.

5. The method of claim 1, wherein the schema relationship is a mapping function between at least one set of tables of the first database and a set of tables of the central database.

6. The method of claim 1, further comprising configuring the at least one processor and the at least one memory including computer program instructions to perform the steps of:
responsive to a request from a user operating a user device remote from said central database, retrieving clinical data from the central database; and
transmitting the retrieved clinical data to the remote user device,
wherein said retrieval of clinical data is dependent on the identity of the user.

7. The method of claim 6, wherein the user device comprises a wearable computing device.

8. The method of claim 1, wherein:
the first clinical data comprises a plurality of fields, each of which has a data format; and
the step of storing the first clinical data in the central database includes converting the data format of at least some of said fields into a format compatible with a data format of corresponding fields of the central database on the basis of a format relationship, the format relationship describing a relationship between the data format of at least some of said fields of the first clinical data and the data format of corresponding fields of the central database.

9. The method of claim 8, further comprising configuring the at least one processor and the at least one memory including computer program instructions to perform the steps of performing a data format comparison process, the data format comparison process comprising the steps of:
receiving first format data indicative of said data format of at least one said field of the first clinical data;
generating a third hash of the first format data;
receiving second format data indicative of said data format of at least one said field of the first clinical data;
generating a fourth hash of the second format data;
comparing the third hash and the fourth hash, whereby to establish that there is a change between the first format data and the second format data; and
responsive to a determination that there is a change, arranging for the format relationship to be updated.

10. The method of claim 9, further comprising configuring the at least one processor and the at least one memory including computer program instructions to perform the data format comparison process for a second field of the first clinical data.

11. The method of claim 10, further comprising configuring the at least one processor and the at least one memory including computer program instructions to selectively perform the data format comparison process for a second said field of the first clinical data based on historical data indicative of how frequently it has been established that there is a change between the first format data and the second format data for a given second field.

12. The method of claim 9, further comprising configuring the at least one processor and the at least one memory including computer program instructions to output an alert indicating that there is said change.

13. The method of claim 9, wherein the step of arranging for the format relationship to be updated comprises:
receiving data indicative of the change; and
updating the format relationship in accordance with the received data so as to incorporate the change between the first and second format data.

14. The method of claim 8, wherein the format relationship is a mapping function between at least one set of formats of fields of the first database and a set of formats of fields of the central database.

15. The method of claim 1, further comprising configuring the at least one processor and the at least one memory including computer program instructions to perform the database structure comparison process on a second database adapted to store clinical data.

16. The method of claim 2, wherein the first clinical data and second clinical data comprises clinical trial data.

17. The method of claim 2, wherein at least some of the first clinical data and at least some of the second clinical data comprises performance monitoring data.

18. A non-transitory computer-readable storage medium comprising a set of computer-readable instructions stored thereon, which, when executed by at least one processor, cause the at least one processor to:
receive a first schema of a first database adapted to store first clinical data;
generate a first hash of the first schema;
receive first clinical data from the first database;
store the first data in a central database using a schema relationship, the schema relationship describing a relationship between the first schema and a schema of the central database;
receive a second schema of the first database;
generate a second hash of the second schema;
compare the first hash and the second hash, whereby to establish that there is a difference between the first schema and the second schema; and
responsive to a determination that there is a difference, selectively arrange for the schema relationship to be updated.

19. An apparatus comprising:
at least one processor; and
at least one memory including computer program instructions;
the at least one memory and the computer program instructions being configured to, with the at least one processor, cause the apparatus to:
receive a first schema of a first database adapted to store first clinical data;
generate a first hash of the first schema;
receive first clinical data from the first database;
store the first data in a central database using a schema relationship, the schema relationship describing a relationship between the first schema and a schema of the central database;
receive a second schema of the first database;
generate a second hash of the second schema;
compare the first hash and the second hash, whereby to establish that there is a difference between the first schema and the second schema; and
responsive to a determination that there is a difference, selectively arrange for the schema relationship to be updated.
